(19) United States
(12) Patent Application Publication
(10) Pub. No.: US 2017/0118384 A1
(43) Pub. Date: Apr. 27, 2017

(54) ADAPTIVE LIGHTING DEVICE FOR OPTICAL INSPECTION

(71) Applicant: NATIONAL APPLIED RESEARCH LABORATORIES, Taipei (TW)

(72) Inventors: Chih-Wen CHEN, Taipei (TW); Ming-Fu CHEN, Taipei (TW); Rui-Cian WENG, Taipei (TW)

(21) Appl. No.: 14/923,401

(22) Filed: Oct. 26, 2015

(51) Int. Cl. H04N 5/225; G06T 7/00; F21V 33/00; F21V 15/01; G01N 21/88; F21V 19/02

(52) U.S. Cl. CPC H04N 5/2256; G01N 21/8806; F21V 19/02; F21V 33/0052; F21V 15/01; H04N 5/2253; G06T 7/0004; G01N 2021/8835; F21Y 2115/10

(57) ABSTRACT

The present disclosure illustrates an adaptive lighting device for optical inspection, which may be assembled with the image capturing device and the lighting module capable of moving and rotating of the lighting device is used to provide a variety of the illumination ranges and the illumination angles for performing an optical inspection. The adaptive lighting device can avoid the separation situation of the flaw and the ghost image of flaw in the inspection image, to achieve the technical effect of raising a correctness rate of the optical inspection effectively.

### BACKGROUND OF THE RELATED ART

Technical Field

The present disclosure is related to an adaptive lighting device for optical inspection, and particularly to a lighting device assembled with an image capturing device, and capable of providing a variety of illumination ranges and illumination angles for an optical inspection system to perform complex optical inspection tasks.

Related Art

Please refer to FIG. 1 which illustrates a perspective assembly view of an existing optical inspection machine.

The existing optical inspection machine includes a first holder 10, a second holder 20, an image capturing device 40 and multiple lighting devices 50.

The first holder 10 is used to place a testing object. The second holder 20 is disposed above the first holder 10, the image capturing device 40 provided with a camera lens 41 and multiple lighting devices 50 are fixed on the second holder 20 correspondingly to perform an optical inspection for the object.

In order to get a high contrast image, a dark field illumination manner is applied when the optical inspection machine performs the optical inspection for a transparent testing object 70. That is, the lighting device 50 illuminates the object 70 by an inclined illumination angle. The strong reflected light of a transparent part on the object 70 is reflected almost and not captured by the image capturing device 40. Thus, the inspection image captured by the image capturing device 40 appears a black part relatively. Because a light illuminated to a flaw part on the object 70 may be scattered, the scattering light may be captured by the image capturing device 40 to form a white part relatively in the inspection image captured by the image capturing device 40. As a result, an inspection image with a high contrast ratio may be acquired. As shown in FIG. 2A, which illustrates an optical inspection image of a transparent object inspected by an existing optical inspection machine.

To increase a quantity of the scattering light, a high reflected layer may be placed under a transparent object 70 (for example, if the transparent object 70 has the reflected layer already, such as a mirror, it is not necessary to place the high reflected layer under the transparent object 70). The optical inspection result is shown in FIG. 2A. As shown in FIG. 2A obviously, the optical inspection result has two white regions. In reality, one of the white regions with a higher gray-scale value is an image of a flaw 71 of the object 70, and the flaw 71 of the object 70 is a target which should be inspected. The other of the white regions with a lower gray-scale value is a ghost image of flaw 72 of the flaw 71 of the object 70. That is, a separation situation of the flaw 71 and the ghost image of flaw 72 is occurred in the existing optical inspection machine.

Based on the result of the two white regions existed in the above optical inspection, there are two possibilities. One is that the object 70 has two flaws 71, and the other is that the object 70 has one flaw 71 and one ghost image of flaw 72 of the flaw 71. Thus, the correctness of the above optical inspection result may be influenced.

If the optical inspection machine is operated to perform optical inspection for an opaque object 70, a different inspection image will be acquired by employing a different illumination manner. An optoelectronic element is taken for example. As shown in FIG. 2B which illustrates an optical inspection image of an opaque object inspected by the existing optical inspection machine with a high illumination angle. The inspection image is acquired for the opaque object 70 by performing the illumination with a high illumination angle close to 90 degree. The brighter part of FIG. 2B is a gold-plated layer. This brighter part is illuminated by the high illumination angle close to 90 degree, so the gold-plated layer reflects light to the image capturing device 40 almost and a high gray-scale part (it's close to white color) is represented in the inspection image. On the contrary, other parts, like a wafer substrate material except the gold-plated layer, may represent a low gray-scale part (it's close to gray color) in the inspection image.

If the same object 70 is performed the optical inspection by other illumination manner, such as the manner of illuminating the object 70 with low illumination angle (the dark field illumination manner), a totally different capturing image will be acquired. Please refer to FIG. 2C which illustrates an optical inspection image of an opaque object inspected by an existing optical inspection machine with a low illumination angle. Because the gold-plated layer is illuminated with a low illumination angle, the light illuminated on the gold-plated layer is reflected with the same low illumination angle as well. Thus, the reflected light is not captured by the image capturing device 40, and the original bright central circles become black. The capturing image of the same object 70 may be changed because of different illumination manners, this is very useful information for optical inspections, and it means that we can base our requirements to choose different illumination manners. However, the existing optical inspection machine needs to be replaced with different lighting device 50 for capturing the different inspection images represented above.

In summary, the existing optical inspection machine can not solve the problem of the ghost image of flaw being separated, and cannot provide a variety of illumination angles and illumination ranges to acquire the different inspection images. As a result, what is need is to propose an improved technical means for solving the problem.

### SUMMARY

An objective of the present disclosure is to provide an adaptive lighting device for optical inspection, and the adaptive lighting device can solve the problem of the ghost image of flaw being separated and provide a stepless illumination angle and illumination range for a free adjustment. In addition, the adaptive lighting device can be easily assembled with an image capturing device, to shorten a distance between the lighting device and the testing object, so a largest illumination effect may be obtained and total power consumption for lighting can be saved.

According to a first embodiment of the present disclosure, an adaptive lighting device for optical inspection includes a first holder, a second holder, an image capturing device and a lighting device. The lighting device further includes a main body, at least one movable part and at least one lighting module.

Preferably, the first holder is used to place a testing object, the second holder is disposed on the same side of the testing object and the image capturing device is set on the second holder and aimed at the testing object. The lighting device is assembled with the image capturing device.

The main body of the lighting device is having a central hole, and the main body of the lighting device is fixed on the image capturing device via the central hole. The at least one movable part of the lighting device is disposed on the main body of the lighting device, respectively, and the movable part of the lighting device can be moved horizontally with respect to the main body of the lighting device. The lighting module of the lighting device is pivoted on the at least one movable part of the lighting device, respectively, and the lighting module of the lighting device can be free rotated with respect to the movable part of the lighting device.

According to a second embodiment of the present disclosure, an adaptive lighting device for optical inspection includes a first holder, a second holder, an image capturing device and a lighting device. The lighting device further includes a retractable component, a main body, at least one movable part and at least one lighting module,

Preferably, the first holder is used to place a testing object, the second holder is disposed on the same side of the testing object and the image capturing device is set on the second holder and aimed at the testing object. The lighting device is assembled with the image capturing device.

The retractable component of the lighting device includes an inner part and an outer part, and each of the inner and outer parts is in a hollow shape. The retractable component of the lighting device is fixed on the image capturing device at one end thereof, and used to make the lighting device vertically movable. The main body of the lighting device is having a central hole, and the central hole of the main body is fixed at the other end of the retractable component of the lighting device. The at least one movable part of the lighting device is disposed on the main body of the lighting device, respectively, and the movable part of the lighting device is horizontally movable with respect to the main body of the lighting device. The lighting module of the lighting device is pivoted on the movable part of the lighting device respectively and the lighting module of the lighting device can be free rotated with respect to the movable part of the lighting device.

According to a third embodiment of the present disclosure, an adaptive lighting device for optical inspection includes a main body, at least one movable part and at least one lighting module.

The main body of the lighting device is having a central hole, and the main body of the lighting device is fixed on external image capturing device via the central hole. The at least one movable part of the lighting device is disposed on the main body of the lighting device, respectively, and the movable part of the lighting device can be moved with respect to the main body of the lighting device. The lighting module of the lighting device is pivoted on the movable part of the lighting device respectively and the lighting module of the lighting device can be free rotated with respect to the movable part of the lighting device.

The difference between above-mentioned devices of the present disclosure and the prior art is that the present disclosure combines the lighting device with the image capturing device, and utilizes the movable and rotatable lighting module of the lighting device to provide a variety of the illumination range and the illumination angle for an optical inspection for the testing object. Therefore, not only the separation of the flaw and the ghost image of flaw in the inspection image can be avoided, but a variety of choices for different illumination angles and illumination ranges may be provided for optical inspection, so as to generate different inspection images. Then, the correctness of the optical inspection or optical identification may be improved greatly.

By the above technical solution, the present disclosure may achieve the technical effect of raising the correctness rate of the optical inspection.

### BRIEF DESCRIPTION OF THE DRAWINGS

The invention will become more fully understood from the detailed description given herein below illustration only, and thus is not limitative of the present invention, and wherein:

FIG. 1 illustrates a perspective assembly view of an existing optical inspection machine.

FIG. 2A illustrates an optical inspection image of a transparent object inspected by an existing optical inspection machine.

FIG. 2B illustrates an optical inspection image of an opaque object inspected by an existing optical inspection machine with a higher illumination angle.

FIG. 2C illustrates an optical inspection image of an opaque object inspected by an existing optical inspection machine with a lower illumination angle.

FIG. 3 illustrates a perspective assembly view of an adaptive lighting device for the optical inspection according to a first embodiment of the present disclosure.

FIG. 4 illustrates an exploded view of a lighting device of an adaptive lighting device for optical inspection according to the first embodiment of the present disclosure.

FIG. 5 illustrates an exploded view of a lighting device, a group of covers and a case of an adaptive lighting device for optical inspection according to the first embodiment of the present disclosure.

FIG. 6 illustrates a perspective assembly view of a lighting device, a group of covers and a case of an adaptive lighting device for optical inspection according to the first embodiment of the present disclosure.

FIG. 7A through FIG. 7C illustrate an schematic plan view of different moving position of a movable part, an schematic plan view of illumination angle of different rotation angle and an schematic plan view of illumination range of different rotation angle of the adaptive lighting device for the optical inspection according to the first embodiment of the present disclosure.

FIG. 8A illustrates a real optical inspection view of the adaptive lighting device for optical inspection of the present disclosure.

FIG. 8B illustrates a real optical inspection view being image-processed of the adaptive lighting device for optical inspection of the present disclosure.

FIG. 9 illustrates a perspective assembly view of an adaptive lighting device for optical inspection according to the second embodiment of the present disclosure.

FIG. 10 illustrates an exploded view of a lighting device of the adaptive lighting device for optical inspection according to the second embodiment of the present disclosure.

FIG. 11 illustrates an exploded view of a lighting device, a group of covers and a case of the adaptive lighting device for optical inspection according to the second embodiment of the present disclosure.

FIG. 12 illustrates a perspective assembly view of a lighting device, a group of covers and a case of the adaptive lighting device for optical inspection according to the second embodiment of the present disclosure.

FIG. 13A through FIG. 13D illustrate an schematic plan view of different moving position of a movable part, an schematic plan view of illumination angle of different rotation angle and an schematic plan view of illumination range of different rotation angle of the adaptive lighting device for optical inspection according to the second embodiment of the present disclosure.

FIG. 14 illustrates an exploded view of a lighting device of the adaptive lighting device for optical inspection according to a third embodiment of the present disclosure.

FIG. 15 illustrates a perspective assembly view of a lighting device of the adaptive lighting device for optical inspection according to the third embodiment of the present disclosure.

FIG. 16 illustrates an exploded view of a lighting device, a group of covers and a case of the adaptive lighting device for optical inspection according to the third embodiment of the present disclosure.

FIG. 17 illustrates a perspective assembly view of a lighting device, a group of covers and a case of the adaptive lighting device for optical inspection according to the third embodiment of the present disclosure.

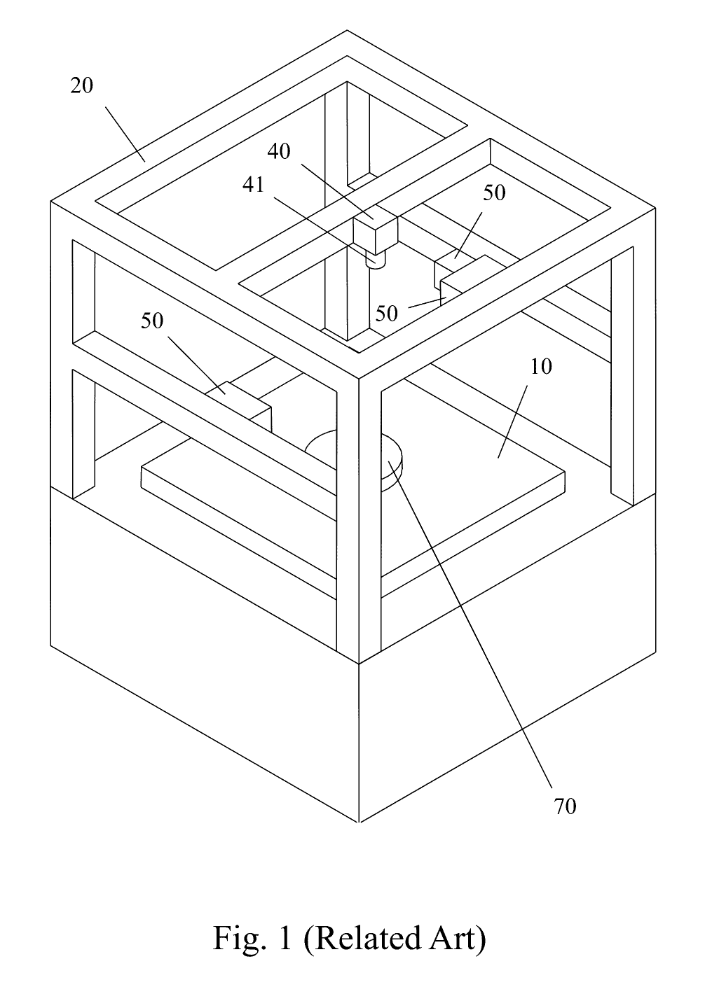

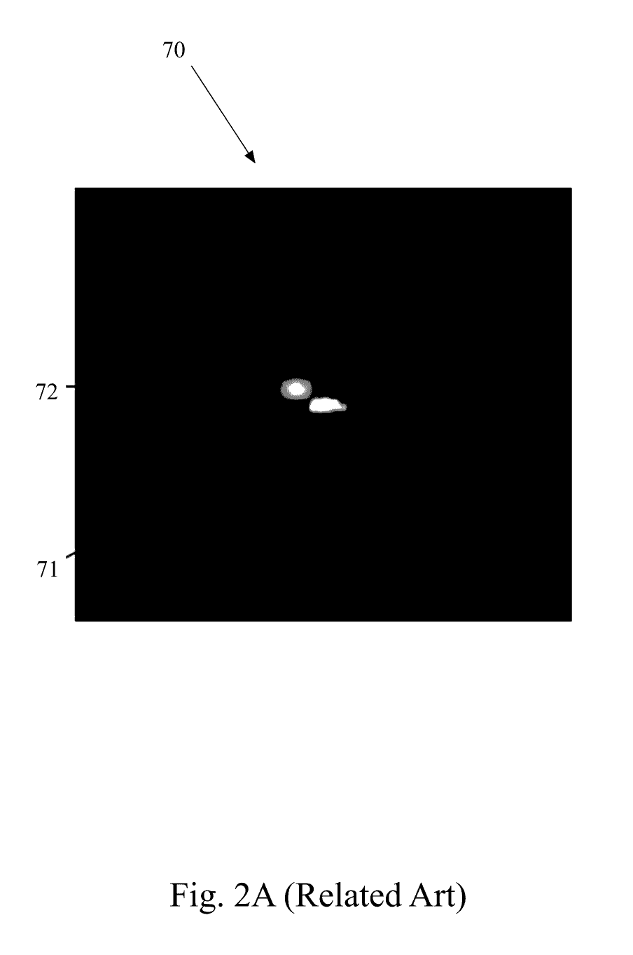

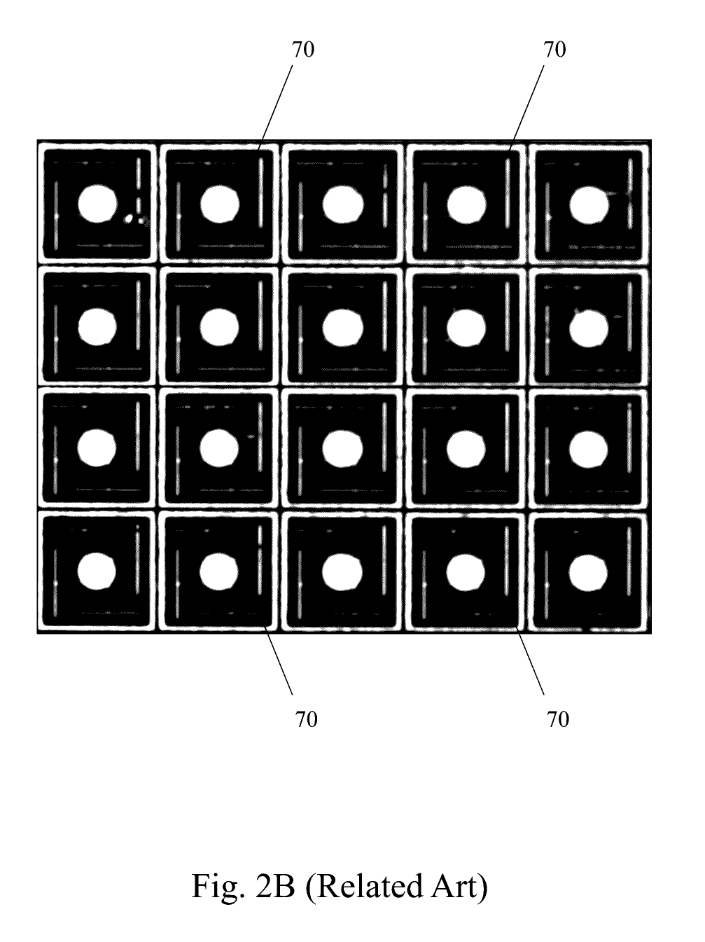

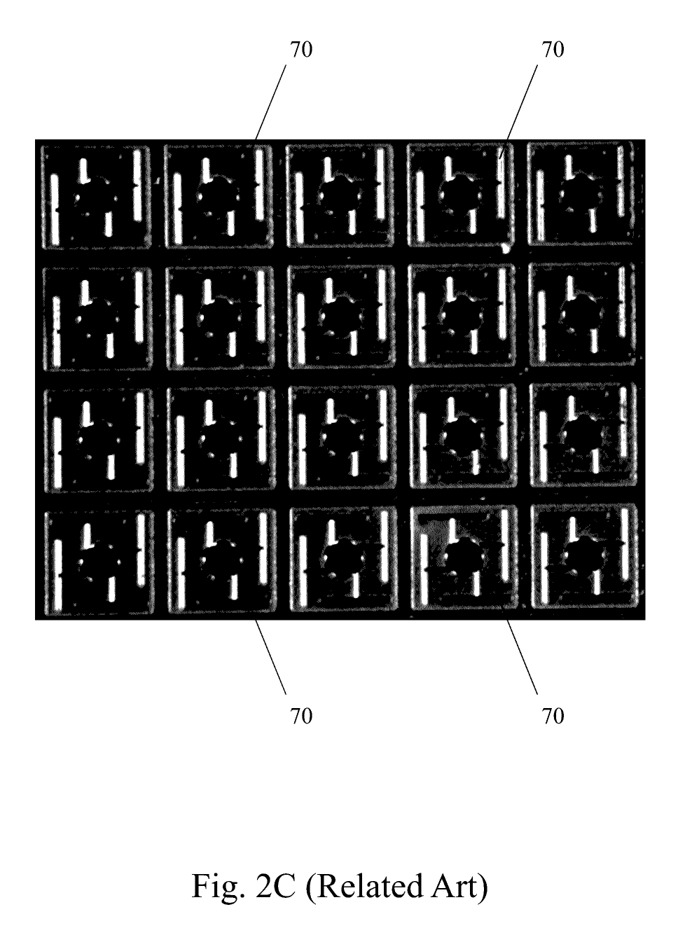

### DETAILED DESCRIPTION

The present invention will be apparent from the following detailed description, which proceeds with reference to the accompanying drawings, wherein the same references relate to the same elements.

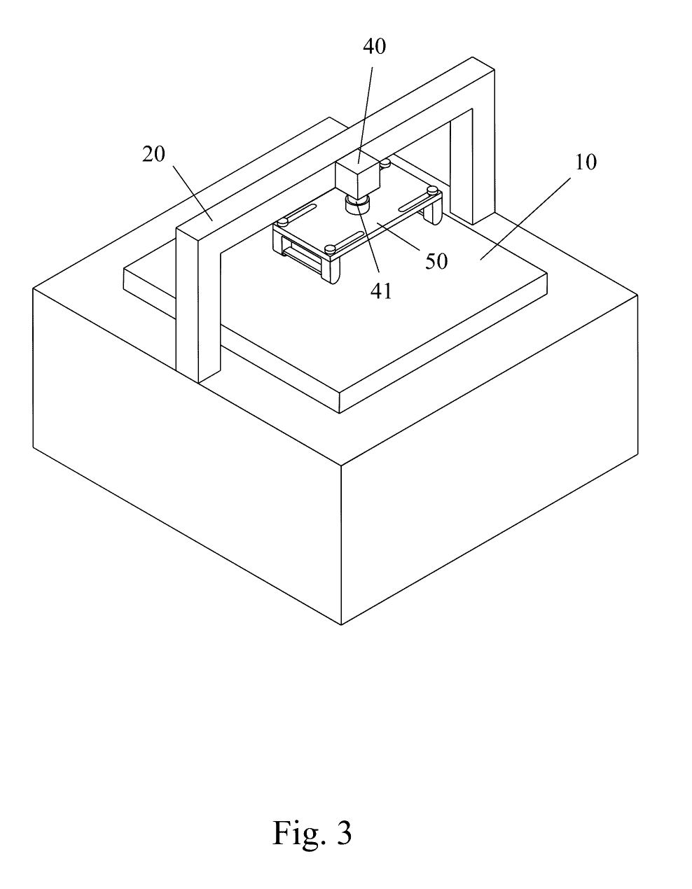

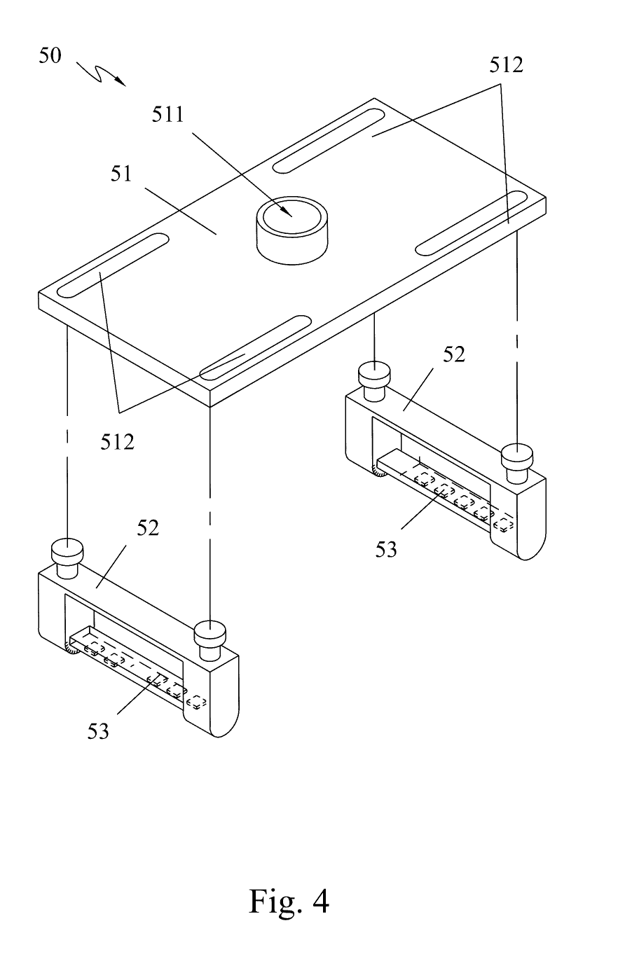

Following description presents an adaptive lighting device for optical inspection according to a first embodiment of the present disclosure first. Please refer to FIG. 3 and FIG. 4 which show a perspective assembly view of an adaptive lighting device for optical inspection according to the first embodiment of the present disclosure, and an exploded view of a lighting device of an adaptive lighting device for optical inspection according to the first embodiment of the present disclosure, respectively.

The adaptive lighting device for optical inspection according to the first embodiment of the present disclosure includes a first holder 10, a second holder 20, an image capturing device 40 and a lighting device 50. The lighting device 50 further includes a main body 51, at least one movable part 52 and at least one lighting module 53.

The first holder 10 is used to place a testing object, and the first holder 10 may drive the object to be moved horizontally. Or, the first holder 10 is immovable. The second holder 20 is disposed on the first holder 10 and the second holder 20 and the testing are disposed on the same side, and the image capturing device 40 is set on the second holder 20. The second holder 20 may also drive the image capturing device 40 set on the second holder 20 to be moved horizontally. Or, the second holder 20 is immovable. The image capturing device 40 is aimed at the testing object.

The main body 51 of the lighting device 50 is provided with a central hole 511, and the central hole 511 may be a circle hole, a square hole, a rectangle hole, a polygon hole and so on. The descriptions represent merely the exemplary embodiment of the present disclosure, without any intention to limit the scope of the present disclosure thereto. The main body of the lighting device 50 is fixed on an apparatus or a camera lens of the image capturing device 40 by using a screw manner, a buckle manner or a tabling manner. The descriptions represent merely the exemplary embodiment of the present disclosure, without any intention to limit the scope of the present disclosure thereto. When the main body 51 of the lighting device 50 is fixed above a camera lens 41 of the image capturing device 40, the camera lens 41 of the image capturing device 40 is located at the central hole 511 of the main body 51.

At least one movable part 52 of the lighting device 50 is disposed at two ends of the main body 51 of lighting device 50, and the movable part 52 of the lighting device 50 can be moved horizontally with respect to the main body 51 of the lighting device 50. In FIG. 4, it's worth noting that the two movable parts 52 of the lighting device 50 are disposed on slide sets 512 of the main body 51 of the lighting device 50 respectively, to enable the two movable parts 52 of the lighting device 50 horizontally movable with respect to the main body 51 of the lighting device 50. The foregoing is illustrative of exemplary embodiments and is not to be construed as limited to the specific embodiments disclosed.

The lighting module 53 of the lighting device 50 is pivoted on the movable part 52 of the lighting device 50 respectively, and the lighting module 53 of the lighting device 50 can be rotated with respect to the movable part 52 of the lighting device 50, to adjust an angle illuminated by the lighting module 53 of the lighting device 50. It's worth noting that the lighting module 53 of the lighting device 50 may include multiple light-emitting diodes to light the object. Besides, the lighting module 53 of the lighting device 50 may have a free 360-degree rotation with respect to the movable part 52 of the lighting device 50. An angle graduation is marked on the movable part 52 of the lighting device 50, to provide a rotating angle reference to the lighting module 53 of the lighting device 50. Thus, the angle adjusted by the lighting module 53 of the lighting device 50 can be known and the illumination angle of the lighting module 53 of the lighting device 50 can be computed further.

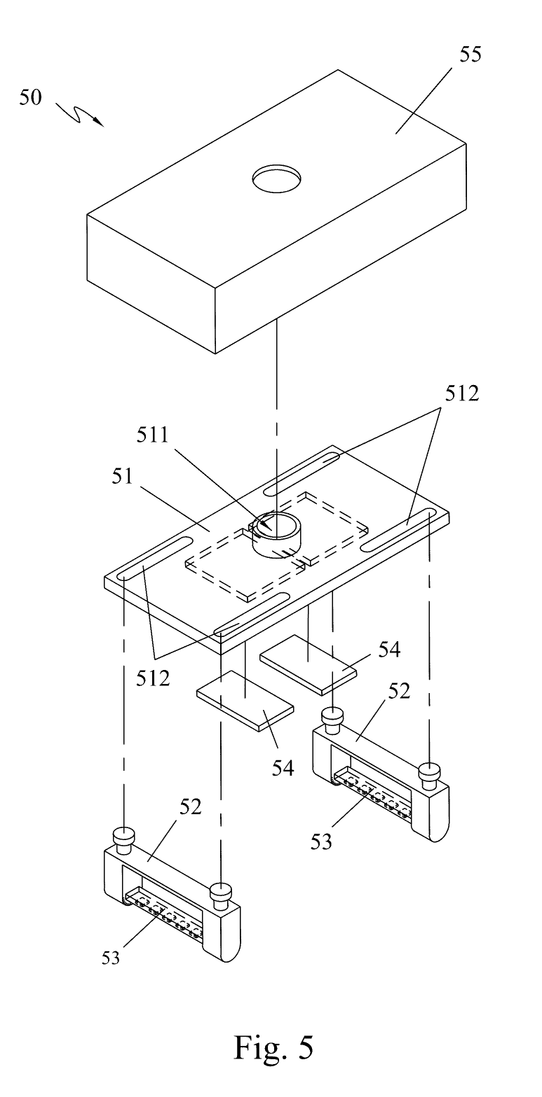

Next, please refer to FIG. 5 which illustrates an exploded view of a lighting device, a group of covers and a case of an adaptive lighting device for optical inspection according to the first embodiment of the present disclosure.

The lighting device 50 may further include a group of covers 54. The group of covers 54 of the lighting device 50 may be disposed on the main body 51 of the light device 50 by using a screw manner, a buckle manner or a tabling manner (the descriptions represent merely the exemplary embodiment of the present disclosure, without any intention to limit the scope of the present disclosure thereto), and the group of covers 54 of the lighting device 50 is used to partially cover the central hole 511 of the main body 51. When the central hole 511 of the main body 51 is covered with a small part by the group of covers 54 of the lighting device 50, the group of covers 54 of the lighting device 50 may provide more light, but the effect of blocking a stray light is less efficient. When the central hole 511 of the main body 51 is covered with a big part by the group of covers 54 of the lighting device 50, the group of covers 54 of the lighting device 50 may provide less light, but the effect of blocking the stray light is more efficient. That is, the group of covers 54 of the lighting device 50 is used to control the amount of the light and the blocking of the stray light, and the group of covers 54 of the lighting device 50 has to be made of an opaque material.

Besides, the main body 51, the movable part 52 and the lighting module 53 of the lighting device 50 may be covered by a case 55 included in the lighting device 50, to protect the main body 51, the movable part 52 and the lighting module 53 of the lighting device 50.

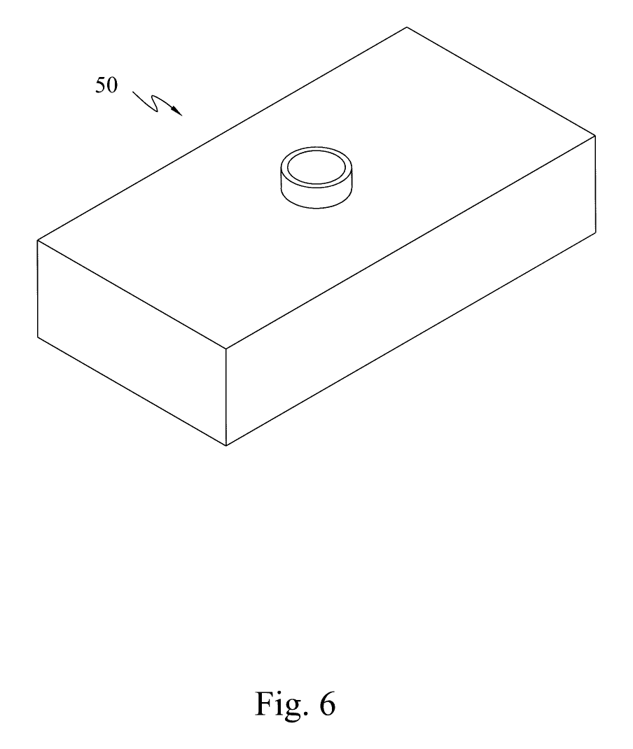

The above main body 51, the movable part 52, the lighting module 53, the group of covers 54 and the case 55 of the lighting device 50 can be assembled to form the lighting device 50. Please refer to FIG. 6 which illustrates a perspective assembly view of a lighting device, a group of covers and a case of the adaptive lighting device for optical inspection according to the first embodiment of the present disclosure.

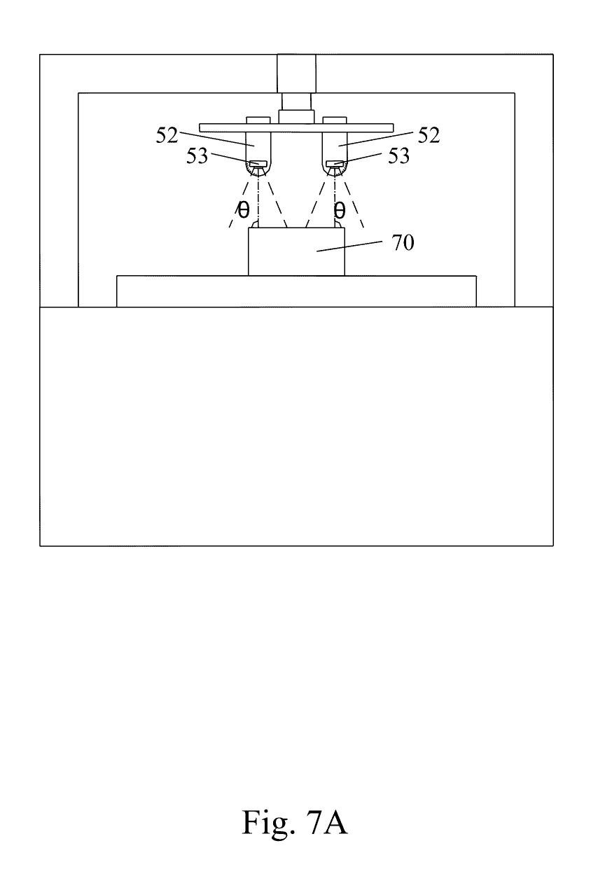

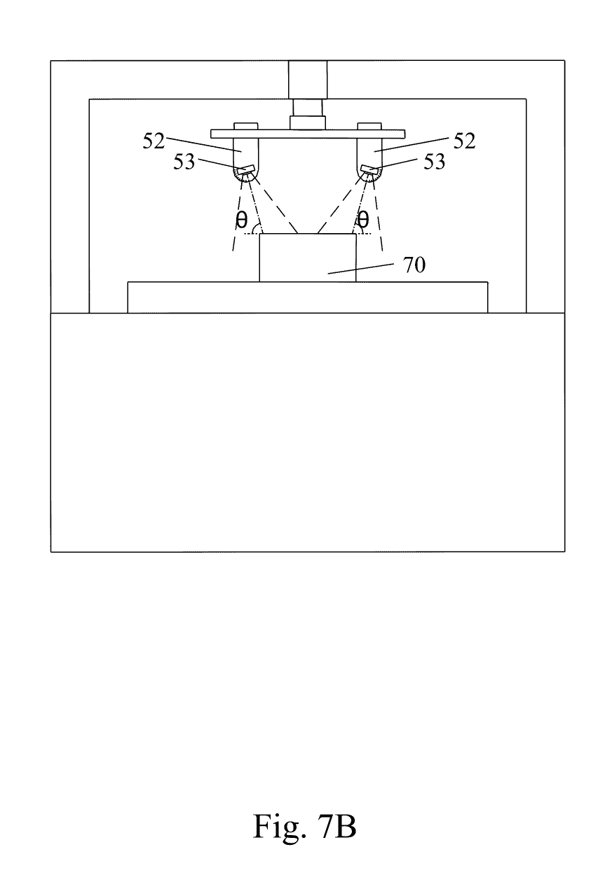

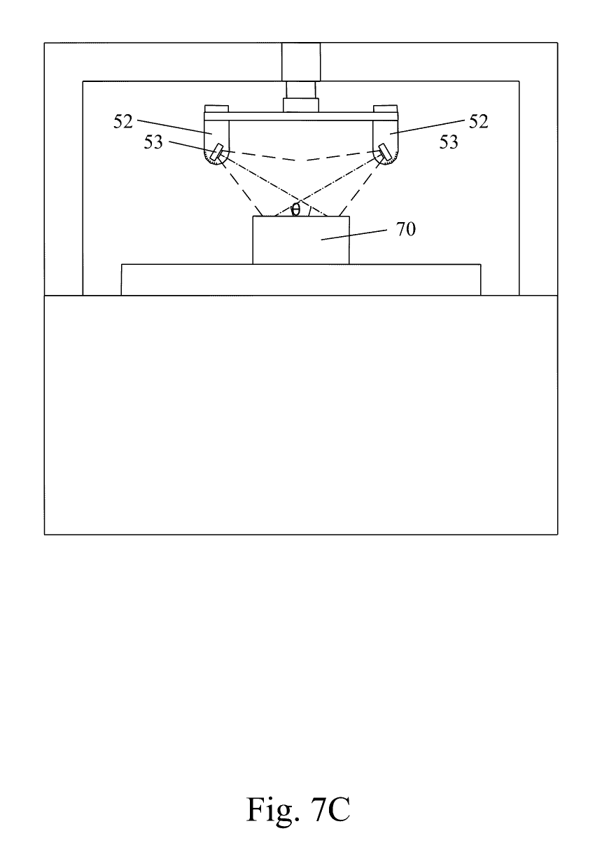

Next, please refer to FIG. 7A through FIG. 7C which illustrate an schematic plan view of different moving position of movable part, an schematic plan view of illumination angle of different rotation angle and an schematic plan view of illumination range of different rotation angle of the adaptive lighting device for optical inspection according to the first embodiment of the present disclosure.

As shown in FIG. 7A, the illumination angle θ of the lighting module 53 of the lighting device 50 is adjusted to illuminate the object 70 with a vertical angle, and based on the illumination angle θ of the lighting module 53 of the lighting device 50, a horizontal position of the lighting module 53 of the lighting device 50 is adjusted by the movable part 52 of the lighting device 50. That is, FIG. 7A is an illumination view that the rotation angle of the lighting module 53 of the lighting device 50 is zero degree, to make the illumination angle θ of the lighting module 53 of the lighting device 50 become 90 degree, and the horizontal position of the lighting module 53 of the lighting device 50 is moved to the position nearest to the object 70 by moving the movable part 52 of the lighting device 50.

As shown in FIG. 7B, the illumination angle θ of the lighting module 53 of the lighting device 50 is adjusted to illuminate the object 70 to be inspected with a high angle, and based on the illumination angle θ of the lighting module 53 of the lighting device 50, a horizontal position of the lighting module 53 of the lighting device 50 is adjusted by moving the movable part 52 of the lighting device 50. That is, the FIG. 7B is an illumination view that the rotation angle of the lighting module 53 of the lighting device 50 is lower than 45 degree, to make the illumination angle θ of the lighting module 53 of the lighting device 50 become higher than 45 degree, and the horizontal position of the lighting module 53 of the lighting device 50 is moved to the appropriate position away from the object 70 by moving the movable part 52 of the lighting device 50.

As shown in FIG. 7C, the illumination angle θ of the lighting module 53 of the lighting device 50 is adjusted to illuminate the testing object 70 with a small angle, and based on the illumination angle θ of the lighting module 53 of the lighting device 50, a horizontal position of the lighting module 53 of the lighting device 50 is adjusted by moving the movable part 52 of the lighting device 50. That is, the FIG. 7C is an illumination view that the rotation angle of the lighting module 53 of the lighting device 50 is higher than 45 degree, to make the illumination angle θ of the lighting module 53 of the lighting device 50 become lower than 45 degree, and the horizontal position of the lighting module 53 of the lighting device 50 is moved to the position farthest to the object 70 by moving the movable part 52 of the lighting device 50.

According to the FIG. 7A through the FIG. 7C, the movable part 52 at different moving positions and the lighting module 53 at different rotation angles may provide the different illumination angles and the different illumination ranges for the object 70. The above descriptions represent merely the exemplary embodiment of the present disclosure, without any intention to limit the scope of the present disclosure thereto.

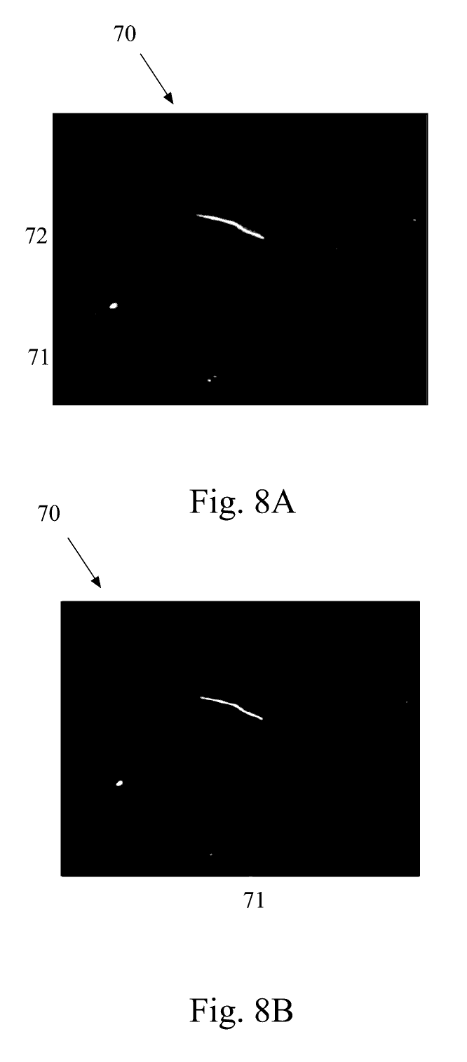

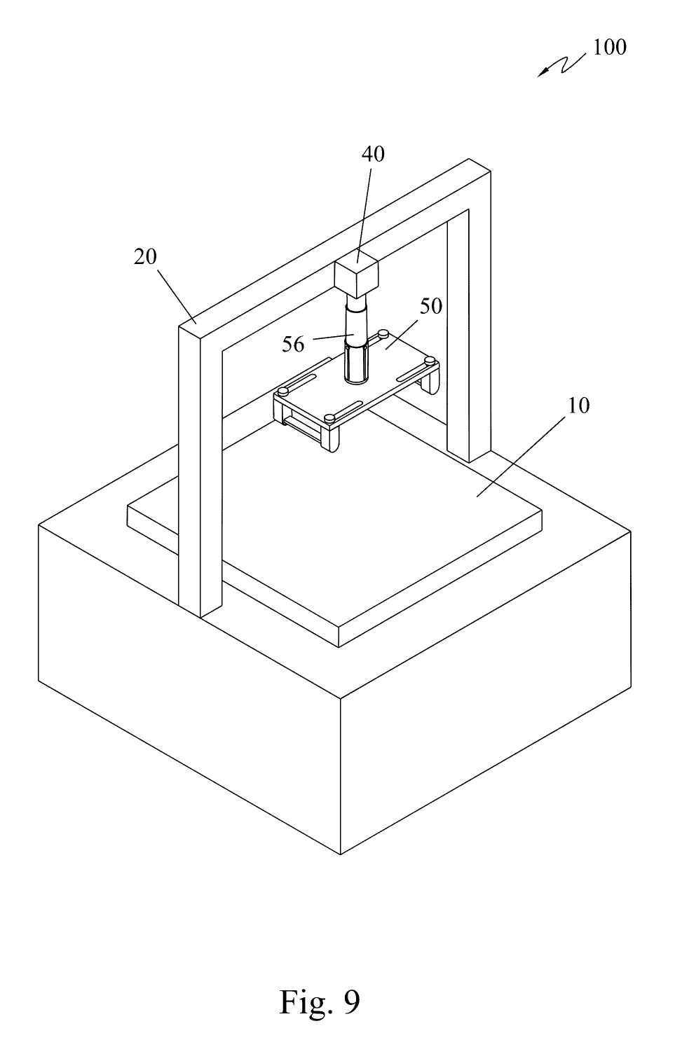

Next, please refer to FIG. 8A and FIG. 8B which illustrate a real optical inspection view of an adaptive lighting device for optical inspection of the present disclosure, and a real optical inspection view being image processed of an adaptive lighting device for optical inspection of the present disclosure, respectively.

The adaptive lighting device for optical inspection disclosed of the first embodiment is used to perform the optical inspection for the object 70 to be inspected, and the optical inspection result is shown in FIG. 8A. As shown in FIG. 8A obviously, for a flaw 71 and a ghost image of flaw 72 on the transparent object 70, the separation problem as the prior arts presented does not happen. The optical inspection result having an image processing for the object 70 is shown in FIG. 8B, and the flaw 71 on the object 70 can be found correctly, so as to avoid the interference of the correction of the optical inspection result influenced by the ghost image of flaw 72.

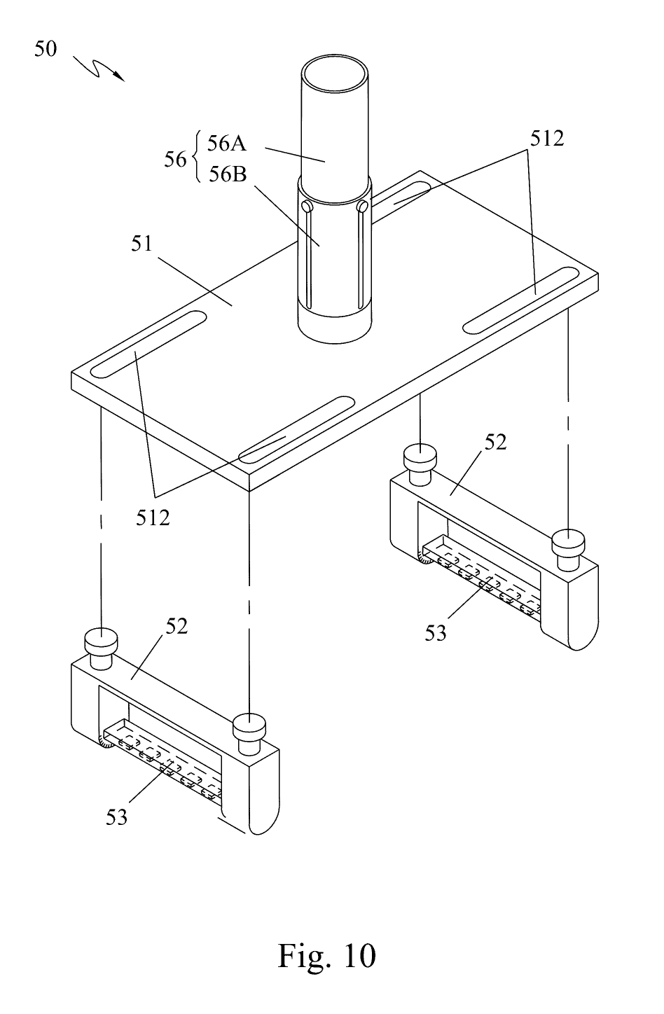

Next, following description presents an adaptive lighting device for optical inspection according to a second embodiment of the present disclosure. Please refer to FIG. 9 and FIG. 10. The FIG. 9 illustrates a perspective assembly view of an adaptive lighting device for optical inspection according to the second embodiment of the present disclosure. The FIG. 10 illustrates an exploded view of a lighting device of an adaptive lighting device for optical inspection according to the second embodiment of the present disclosure.

The adaptive lighting device for optical inspection according to the second embodiment of the present disclosure includes a first holder 10, a second holder 20, an image capturing device 40 and a lighting device 50. The lighting device 50 further includes a retractable component 56, a main body 51, at least one movable part 52 and at least one lighting module 53.

The first holder 10 is used to place a testing object, and the first holder 10 may drive the object to be moved horizontally. Or, the first holder 10 is immovable. The second holder 20 is disposed above the first holder 10 and the image capturing device 40 is set on the second holder 20. The second holder 20 may also drive the image capturing device 40 set on the second holder 20 to be moved horizontally. Or, the second holder 20 is immovable.

The retractable component 56 of the lighting device 50 may be composed of an inner part 56A and an outer part 56B, and the two parts are independent from one another and formed a hollow cylinder, or be composed of a similar way of a traditional folding camera (please refer to the description of existing technology about the traditional folding camera, and the detailed description is omitted here). The retractable component 56 of the lighting device 50 may be fixed (the figure presents the inner part 56A, and it may be the outer part 56B as well in reality) on an apparatus of the image capturing device 40 or a camera lens 41 at one end thereof by using a screw manner, a buckle manner or a tabling manner. The descriptions represent merely the exemplary embodiment of the present disclosure, without any intention to limit the scope of the present disclosure thereto. Besides, the inner part 56A and the outer part 56B of the retractable component 56 of the lighting device 50 are used to make the lighting device 50 vertically movable. The difference between the first embodiment and the second embodiment is that the second embodiment extra has a freedom degree for moving vertically by adding the retractable component 56 of the lighting device 50, to adjust a vertical distance from the lighting device 50 to the object 70 and further change the illumination range.

The main body 51 of the lighting device 50 is provided with a central hole 511, and the central hole 511 may be a circle hole, a square hole, a rectangle hole, a polygon hole and so on. The descriptions represent merely the exemplary embodiment of the present disclosure, without any intention to limit the scope of the present disclosure thereto. The main body 51 of the lighting device 50 may be fixed at the other end of the retractable component 56 of the lighting device 50 (the figure presents the outer part 56B, and it may be the inner part 56A as well in reality) by using a screw manner, a buckle manner or a tabling manner, or a V-shaped groove (the descriptions represent merely the exemplary embodiment of the present disclosure, without any intention to limit the scope of the present disclosure thereto).

At least one movable part 52 of the lighting device 50 is disposed at the two ends of the main body 51 of lighting device 50, and the movable part 52 of the lighting device 50 can be moved horizontally with respect to the main body 51 of the lighting device 50. In FIG. 10, it's worth noting that the two movable parts 52 of the lighting device 50 are disposed on two slide sets 512 of the main body 51 of the lighting device 50, respectively, so as to enable the movable part 52 of the lighting device 50 to be moved horizontally with respect to the main body 51 of the lighting device 50. The foregoing is illustrative of exemplary embodiments and is not to be construed as limited to the specific embodiments disclosed.

The lighting module 53 of the lighting device 50 is pivoted on the movable part 52 of the lighting device 50 respectively, and the lighting module 53 of the lighting device 50 can be rotated with respect to the movable part 52 of the lighting device 50, to adjust an angle illuminated by the lighting module 53 of the lighting device 50. It's worth noting that the lighting module 53 of the lighting device 50 includes multiple light-emitting diodes to provide illumination for lighting the testing object, and the lighting module 53 of the lighting device 50 may have a free 360-degree rotation with respect to the movable part 52 of the lighting device 50. An angle graduation is marked on the movable part 52 of the lighting device 50, to provide a rotating angle reference to the lighting module 53 of the lighting device 50. Thus, the angle adjusted by the lighting module 53 of the lighting device 50 can be known and the illumination angle of the lighting module 53 of the lighting device 50 can be computed further.

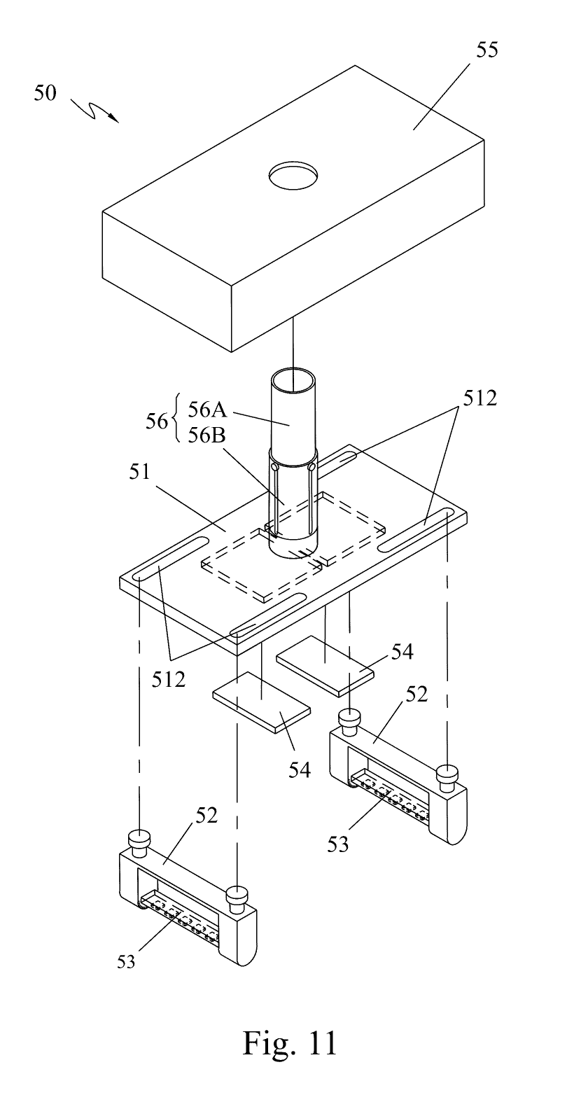

Next, please refer to FIG. 11 which illustrates an exploded view of a lighting device, a group of covers and a case of the adaptive lighting device for optical inspection according to the second embodiment of the present disclosure.

The lighting device 50 may further include a group of covers 54. The group of covers 54 of the lighting device 50 may be disposed on the main body 51 of the light device 50 by using a screw manner, a buckle manner or a tabling manner (the descriptions represent merely the exemplary embodiment of the present disclosure, without any intention to limit the scope of the present disclosure thereto), and the group of covers 54 of the lighting device 50 is partially covered by the central hole 511 of the main body 51. When the central hole 511 of the main body 51 is covered with a small part by the group of covers 54 of the lighting device 50, the group of covers 54 of the lighting device 50 may provide more light, but the effect of blocking a stray light can be less efficient. When the central hole 511 of the main body 51 is covered with a big part by the group of covers 54 of the lighting device 50, the group of covers 54 of the lighting device 50 may provide less light, but the effect of blocking the stray light can be more efficient. That is, the group of covers 54 of the lighting device 50 is used for the control of light and the blocking of the stray light, so the group of covers 54 of the lighting device 50 has to be made of an opaque material.

In addition, the main body 51, the movable part 52 and the lighting module 53 of the lighting device 50 may be covered by the case 55 included by the lighting device 50, to protect the main body 51, the movable part 52 and the lighting module 53 of the lighting device 50.

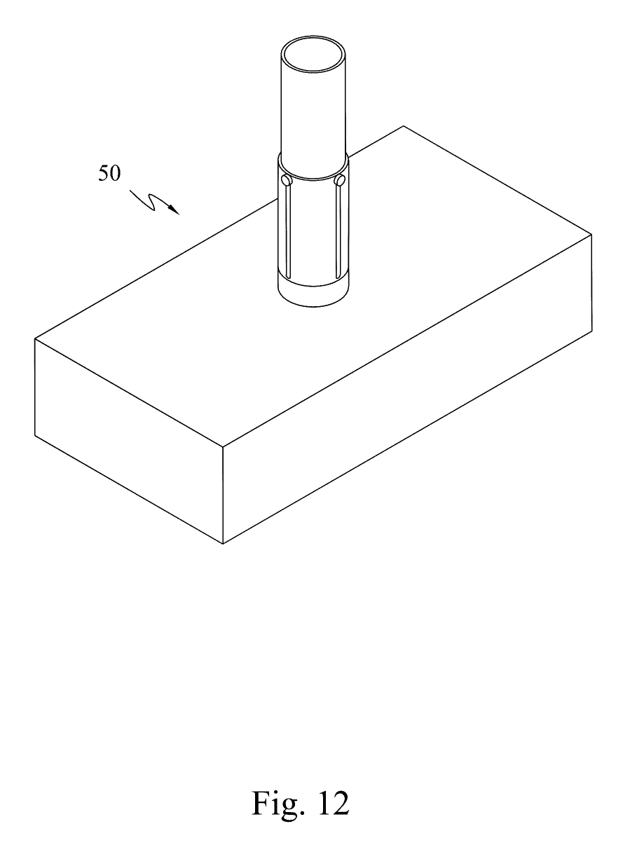

By combining the above main body 51, the movable part 52, the lighting module 53, the group of covers 54 and the case 55 of the lighting device 50, the lighting device 50 is formed. Please refer to FIG. 12 which illustrates a perspective assembly view of a lighting device, a group of covers and a case of the adaptive lighting device for optical inspection according to the second embodiment of the present disclosure.

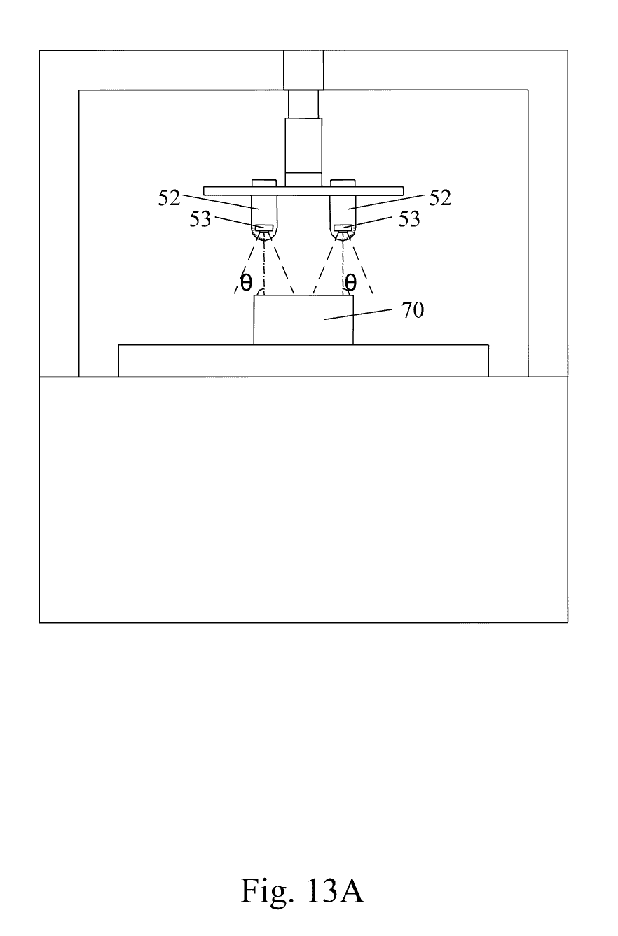

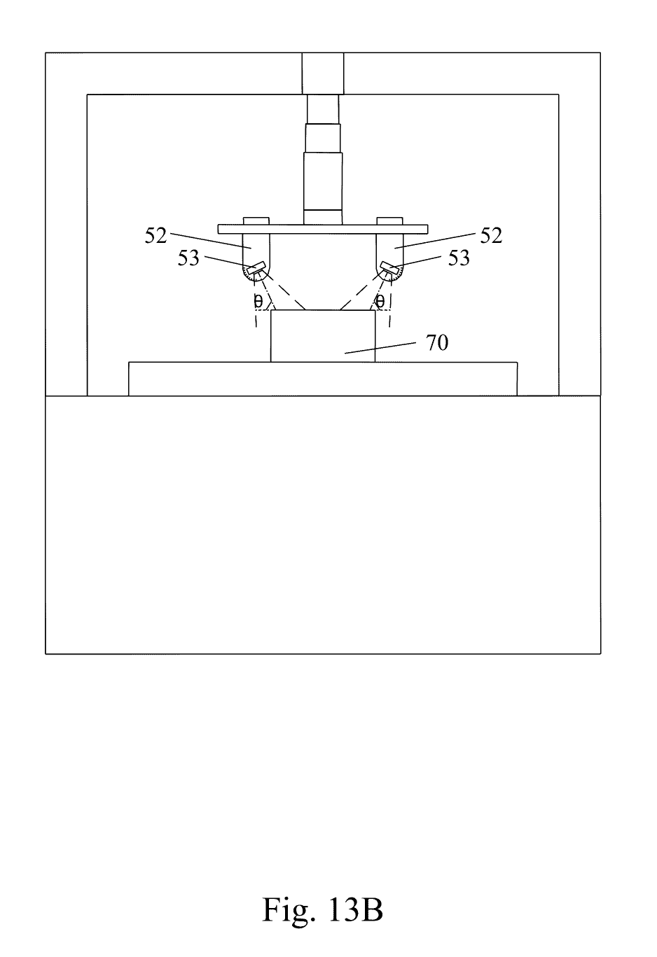

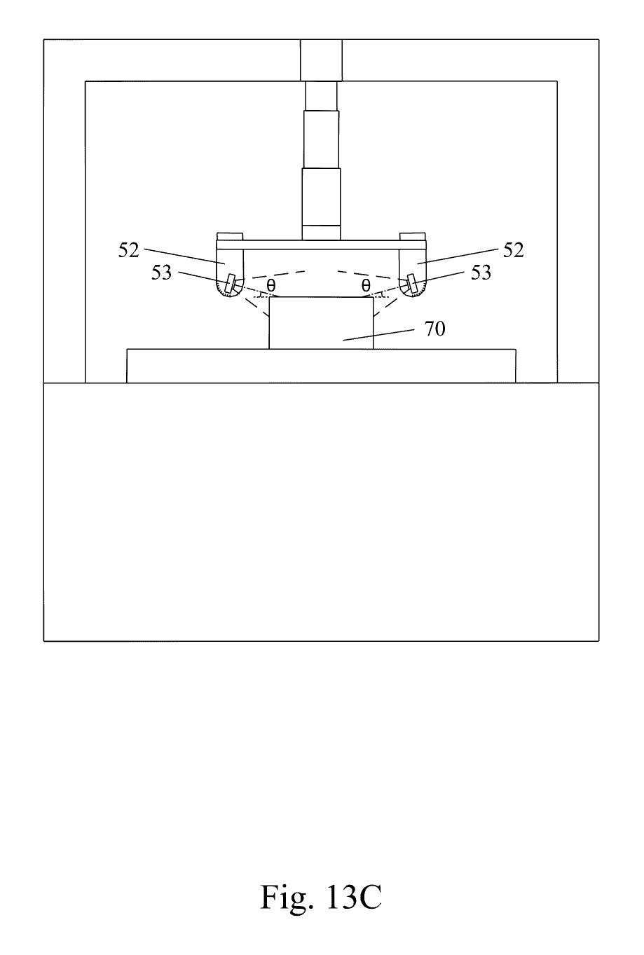

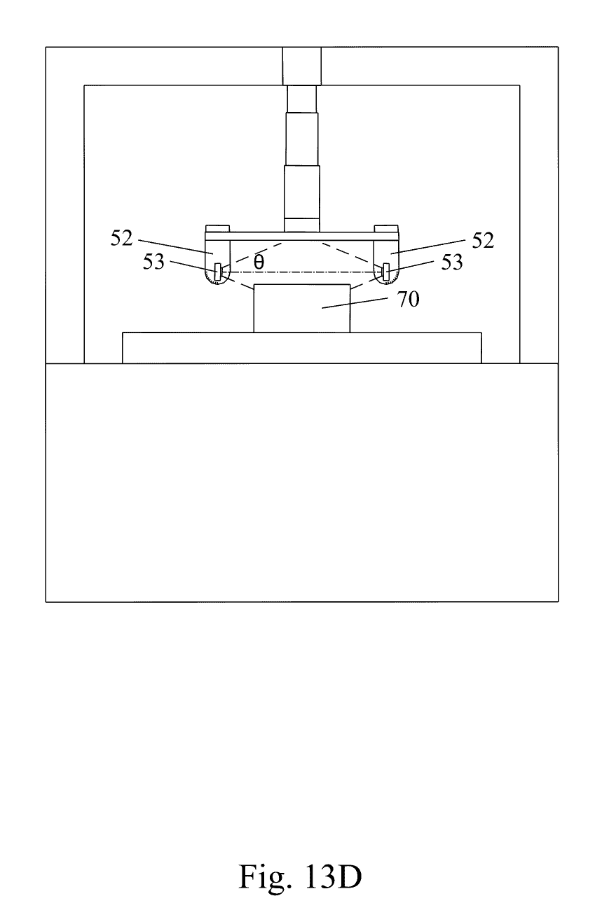

Next, please refer to FIG. 13A through FIG. 13D which illustrate schematic plan views of different moving position of the retractable component and different moving position of movable part, an schematic plan view of illumination angle of different rotation angle and an schematic plan view of illumination range of different rotation angle of an adaptive lighting device for optical inspection according to the second embodiment of the present disclosure.

In FIG. 13A, the inner part 56A of the retractable component 56 is contained by the outer part 56B completely. The illumination angle θ of the lighting module 53 of the lighting device 50 is adjusted to illuminate the object 70 with a vertical angle, and based on the illumination angle θ of the lighting module 53 of the lighting device 50, a horizontal position of the lighting module 53 of the lighting device 50 is adjusted by the movable part 52 of the lighting device 50. That is, the FIG. 13A is an illumination view that the rotation angle of the lighting module 53 of the lighting device 50 is zero degree, to make the illumination angle θ of the lighting module 53 of the lighting device 50 become 90 degree, and the horizontal position of the lighting module 53 of the lighting device 50 is moved to the position nearest to the object 70 by the movable part 52 of the lighting device 50.

In FIG. 13B, half of the inner part 56A of the retractable component 56 is contained by the outer part 56B. The illumination angle θ of the lighting module 53 of the lighting device 50 is adjusted to illuminate the testing object 70 with a high angle, and based on the illumination angle θ of the lighting module 53 of the lighting device 50, a horizontal position of the lighting module 53 of the lighting device 50 is adjusted by the movable part 52 of the lighting device 50. That is, the FIG. 13B is an illumination view illustrates that the rotation angle of the lighting module 53 of the lighting device 50 is lower than 45 degree, to make the illumination angle θ of the lighting module 53 of the lighting device 50 be higher than 45 degree, and the horizontal position of the lighting module 53 of the lighting device 50 is moved to an appropriate position remote from the object 70 by the movable part 52 of the lighting device 50.

In FIG. 13C, the inner part 56A and the outer part 56B of the retractable component 56 are spread completely. The illumination angle θ of the lighting module 53 of the lighting device 50 is adjusted to light the testing object 70 with a low angle, and based on the illumination angle θ of the lighting module 53 of the lighting device 50, a horizontal position of the lighting module 53 of the lighting device 50 is adjusted by the movable part 52 of the lighting device 50. That is, the FIG. 13C is an illumination view illustrates that the rotation angle of the lighting module 53 of the lighting device 50 is higher than 45 degree, to make the illumination angle θ of the lighting module 53 of the lighting device 50 be lower than 45 degree, and the horizontal position of the lighting module 53 of the lighting device 50 is moved to the position farthest to the object 70 by the movable part 52 of the lighting device 50.

In FIG. 13D, the inner part 56A and the outer part 56B of the retractable component 56 are spread completely. The illumination angle θ of the lighting module 53 of the lighting device 50 is adjusted to illuminate the object 70 with a horizontal angle, and based on the illumination angle θ of the lighting module 53 of the lighting device 50, a horizontal position of the lighting module 53 of the lighting device 50 is adjusted by the movable part 52 of the lighting device 50. That is, the FIG. 13D is an illumination view that the rotation angle of the lighting module 53 of the lighting device 50 is 90 degree, to make the illumination angle θ of the lighting module 53 of the lighting device 50 become a horizontal degree, and the horizontal position of the lighting module 53 of the lighting device 50 is moved to the position farthest to the object 70 by the movable part 52 of the lighting device 50.

As shown in FIG. 13A through FIG. 13D, according to the different moving positions spread by the retractable component 56, the different moving positions of the movable part 52 and the different rotation angles of the lighting module 53, the different illumination angles and the different illumination ranges of the object 70 may be presented. The above descriptions represent merely the exemplary embodiment of the present disclosure, without any intention to limit the scope of the present disclosure thereto.

By using the adaptive lighting device for optical inspection disclosed in the second embodiment to have a real optical inspection, the results shown in FIG. 8A and FIG. 8B can also be easily achieved in the same way.

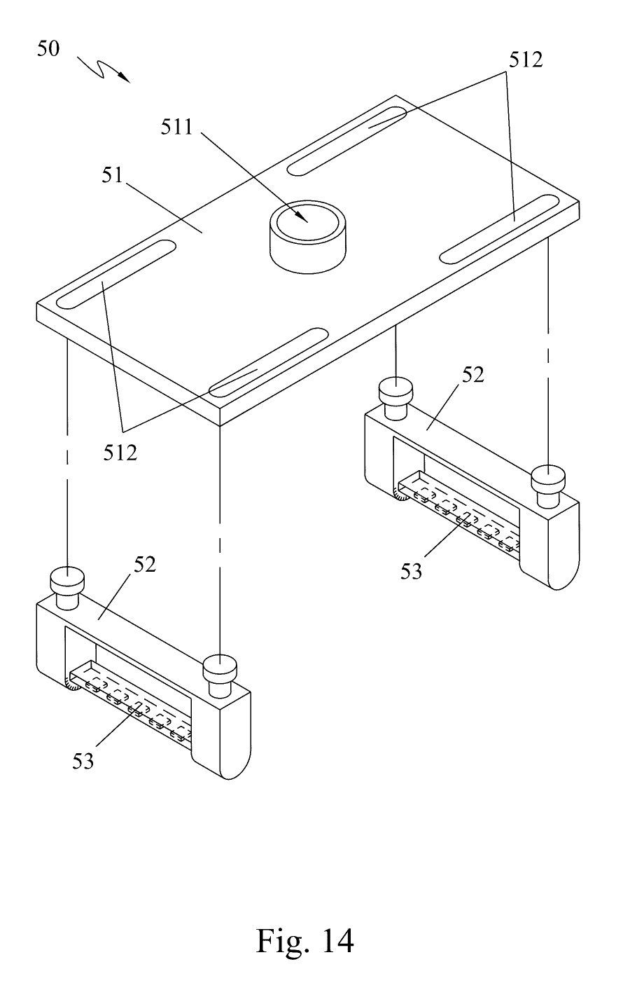

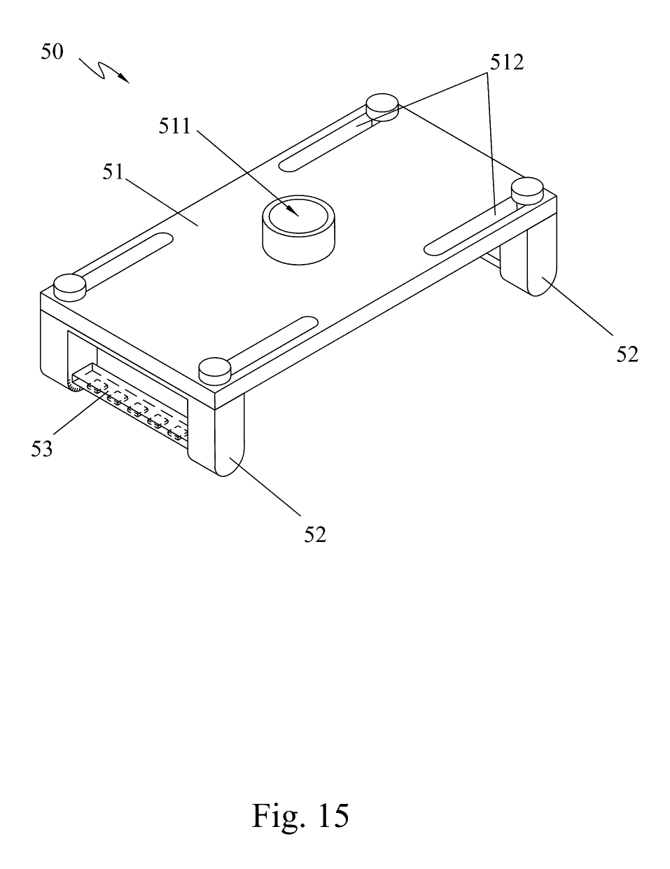

Next, please refer to FIG. 14 and FIG. 15 which illustrate an exploded view of a lighting device of an adaptive lighting device for optical inspection according to a third embodiment of the present disclosure, and a perspective assembly view of a lighting device of the adaptive lighting device for optical inspection according to the third embodiment of the present disclosure, respectively.

The third embodiment of the present disclosure illustrates the adaptive lighting device for optical inspection. The light device 50 includes a main body 51, at least one movable part 52 and at least one lighting module 53.

The main body 51 of the lighting device 50 is provided with a central hole 511, and the central hole 511 may be a circle hole, a square hole, a rectangle hole, a polygon hole and so on. The descriptions represent merely the exemplary embodiment of the present disclosure, without any intention to limit the scope of the present disclosure thereto. The main body 51 of the lighting device 50 may be fixed on an apparatus of the outside image capturing device or a camera lens of the outside image capturing device by using a screw manner, a buckle manner or a tabling manner. The descriptions represent merely the exemplary embodiment of the present disclosure, without any intention to limit the scope of the present disclosure thereto. When the main body 51 of the lighting device 50 is fixed above the camera lens of the outside image capturing device, the camera lens of the image capturing device is located at the central hole 511 of the main body 51.

At least one movable part 52 of the lighting device 50 is disposed at two ends of the main body 51 of lighting device 50, and the movable part 52 of the lighting device 50 can be moved horizontally with respect to the main body 51 of the lighting device 50. In FIG. 14, it's worth noting that two movable parts 52 of the lighting device 50 are disposed on slide sets 512 of the main body 51 of the lighting device 50 respectively, to enable the two movable parts 52 of the lighting device 50 to be moved horizontally with respect to the main body 51 of the lighting device 50. The foregoing is illustrative of exemplary embodiments and is not to be construed as limited to the specific embodiments disclosed.

The lighting module 53 of the lighting device 50 is pivoted on the movable part 52 of the lighting device 50 respectively, and the lighting module 53 of the lighting device 50 can be rotated with respect to the movable part 52 of the lighting device 50, to adjust illumination angle of the lighting module 53 of the lighting device 50. It's worth noting that the lighting module 53 of the lighting device 50 includes multiple light-emitting diodes to provide illumination for lighting the testing object. Besides, the lighting module 53 of the lighting device 50 may have a free 360-degree rotation with respect to the movable part 52 of the lighting device 50. An angle graduation is marked on the movable part 52 of the lighting device 50, to provide a rotating angle reference to the lighting module 53 of the lighting device 50, Thus, the angle adjusted by the lighting module 53 of the lighting device 50 can be known and the illumination angle of the lighting module 53 of the lighting device 50 can be computed further.

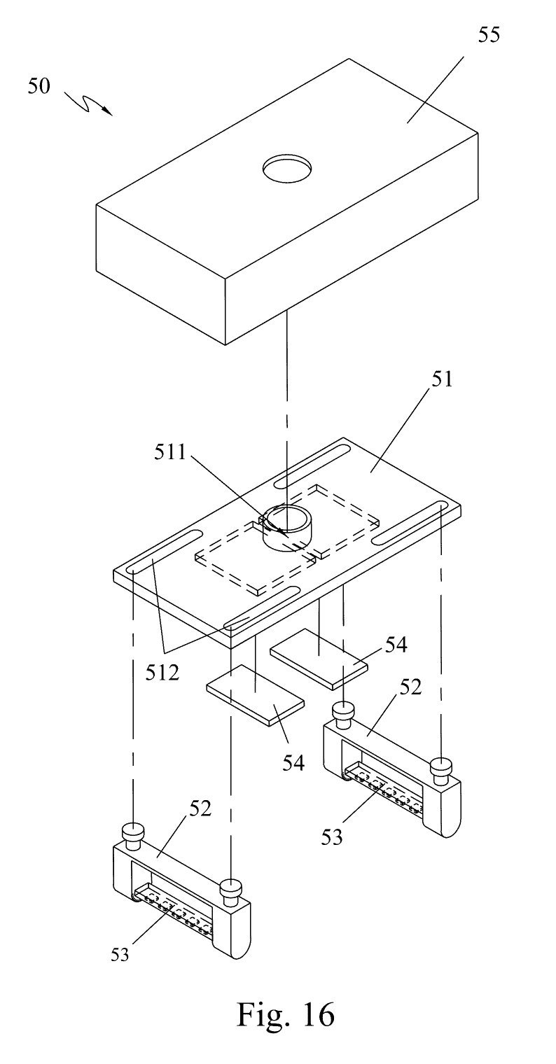

Next, please refer to FIG. 16 which illustrates an exploded view of a lighting device, a group of covers and a case of the adaptive lighting device for optical inspection according to the third embodiment of the present disclosure.

The lighting device 50 may further include a group of covers 54. The group of covers 54 of the lighting device 50 may be disposed on the main body 51 of the light device 50 by using a screw manner, a buckle manner or a tabling manner (the descriptions represent merely the exemplary embodiment of the present disclosure, without any intention to limit the scope of the present disclosure thereto), and the central hole 511 of the main body 51 is partially covered by the group of covers 54 of the lighting device 50 provides. When the central hole 511 of the main body 51 is covered with a small part by the group of covers 54 of the lighting device 50, the group of covers 54 of the lighting device 50 may provide more light, but the effect of blocking a stray light is less efficient. When the central hole 511 of the main body 51 is covered with a big part by the group of covers 54 of the lighting device 50, the group of covers 54 of the lighting device 50 may provide less light, but the effect of blocking the stray light is more efficient. That is, the group of covers 54 of the lighting device 50 is used for the control of light and the blocking of the stray light, so the group of covers 54 of the lighting device 50 has to be made of an opaque material.

In addition, the main body 51, the movable part 52 and the lighting module 53 of the lighting device 50 may be covered by the case 55 included by the lighting device 50, to protect the main body 51, the movable part 52 and the lighting module 53 of the lighting device 50.

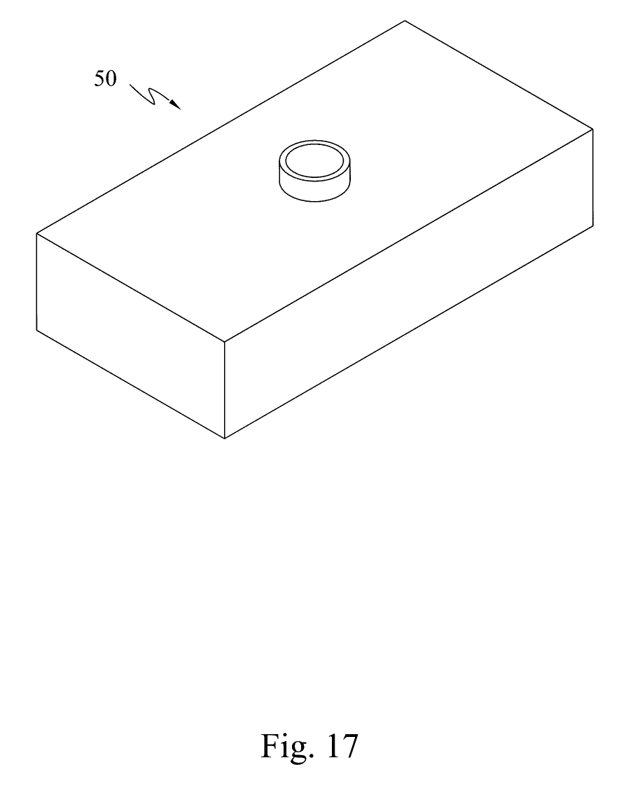

By combining the above main body 51, the movable part 52, the lighting module 53, the group of covers 54 and the case 55 of the lighting device 50, the lighting device 50 is formed. Please refer to FIG. 17 which illustrates a perspective assembly view of a lighting device, a group of covers and a case of the adaptive lighting device for optical inspection according to the third embodiment of the present disclosure.

In summary, the difference between the present disclosure and the prior art is that the present disclosure combines the lighting device with the image capturing device, and uses the lighting module capable of moving and rotating of the lighting device to perform the optical inspection for the testing object by providing a variety of illumination ranges and illumination angles. Not only the separation situation of the flaw and the ghost image of flaw in the inspection image can be avoided, but a variety of choices for the different illumination angles and illumination ranges may be provided for the optical inspection, so as to generate the different inspection images. Then, the correctness of the optical inspection or the optical identification may be improved greatly.

By the disclosed technical means, the existing problem of the separation situation of the flaw and the ghost image of flaw in the prior arts can be solved, and the problem that different inspection images not being provided at the same time under a variety of illumination angles and illumination ranges in the prior arts can be solved as well, so as to further achieve the technical effect of raising the correctness rate of the optical inspection effectively.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An adaptive lighting device for optical inspection, comprising:
a first holder, used to place a testing object;
a second holder, disposed on the same side of the testing object;
an image capturing device, set on the second holder and aimed at the testing object; and
a lighting device, assembled with the image capturing device, and further comprising:
a main body, having a central hole and fixed on the image capturing device;
at least one movable part, disposed on the main body respectively, and the at least one movable part being horizontally movable with respect to the main body; and
at least one lighting module, pivoted on the at least one movable part respectively, and the at least one lighting module free rotated with respect to the at least one movable part.

2. The adaptive lighting device as defined in claim 1, wherein the at least one movable part is disposed on slide set of the main body respectively, to be moved with respect to the main body.

3. The adaptive lighting device as defined in claim 1, wherein the at least one lighting module comprises multiple light-emitting diodes (LEDs), to light the testing object.

4. The adaptive lighting device as defined in claim 1, wherein an angle graduation is marked on the at least one movable part, to provide a rotation angle reference to the at least one lighting module.

5. The adaptive lighting device as defined in claim 1, wherein the lighting device further comprises a group of covers disposed on the main body to block a stray light.

6. The adaptive lighting device as defined in claim 1, wherein the main body is fixed on the image capturing device via the central hole.

7. An adaptive lighting device for optical inspection, comprising:
a first holder, used to place a testing object;
a second holder, disposed on the same side of the testing object;
an image capturing device, set on the second holder and aimed at the testing object;
a lighting device, assembled with the image capturing device, and further comprising:
a retractable component, comprising an inner part and an outer part, and each of the inner and outer parts being in a hollow shape, and the retractable component fixed on the image capturing device at one end thereof and used to enable the lighting device vertically movable;
a main body, having a central hole, and the central hole being fixed at the other end of the retractable component;
at least one movable part, disposed on the main body respectively, and the at least one movable part being horizontally moved with respect to the main body; and
at least one lighting module, pivoted on the at least one movable part respectively, and the at least one lighting module being free rotated with respect to the at least one movable part.

8. The adaptive lighting device as defined in claim 7, wherein the at least one movable part is disposed on slide set of the main body respectively, to be moved with respect to the main body.

9. The adaptive lighting device as defined in claim 7, wherein the at least one lighting module comprises multiple light-emitting diodes (LEDs), to light the testing object.

10. The adaptive lighting device as defined in claim 7, wherein an angle graduation is marked on the at least one movable part, to provide a rotating angle reference to the at least one lighting module.

11. The adaptive lighting device as defined in claim 7, wherein the lighting device further comprises a group of covers disposed on the main body to block a stray light.

12. An adaptive lighting device for optical inspection, comprising:
a main body, having a central hole, and fixed on external image capturing device;
at least one movable part, disposed on the main body respectively, and the at least one movable part being moved with respect to the main body; and
at least one lighting module, pivoted on the at least one movable part respectively, and the at least one lighting module being free rotated with respect to the at least one movable part.

13. The adaptive lighting device as defined in claim 12, wherein the at least one movable part is disposed on a slide set of the main body respectively, to be moved with respect to the main body.

14. The adaptive lighting device as defined in claim 12, wherein the at least one lighting module comprises multiple light-emitting diodes (LEDs), to provide illumination for lighting the testing object.

15. The adaptive lighting device as defined in claim 12, wherein an angle graduation is marked on the at least one movable part, to provide a rotating angle reference to the at least one lighting module.

16. The adaptive lighting device as defined in claim 12, wherein the lighting device further comprises a group of covers disposed on the main body to block a stray light.
